(19) United States
(12) Patent Application Publication
(10) Pub. No.: US 2006/0053665 A1
(43) Pub. Date: Mar. 16, 2006

(54) Trench wall cutter

(76) Inventors: Maximilian Arzberger, Igenhausen (DE); Ignaz Anton Seitle, Karlshuld (DE)

Correspondence Address: JACOBSON HOLMAN PLLC, 400 SEVENTH STREET N.W., SUITE 600, WASHINGTON, DC, 20004, US

(21) Appl. No.: 11/227,910

(22) Filed: Sep. 16, 2005

(30) Foreign Application Priority Data
Sep. 16, 2004 (EP) 04 022 096.4

(51) Int. Cl. B65G 15/00

(52) U.S. Cl. 37/352

(57) ABSTRACT

The invention relates to a trench wall cutter with a cutting frame, a bearing bracket located on the cutting frame, a drive fitted to the cutting frame spaced from the bearing bracket, a transmission or gear located in the bearing bracket, and a drive shaft transmitting a drive torque to the transmission in the bearing bracket. For improved lubrication purposes, the drive shaft at least partly has an external thread constructed as a feed thread for feeding lubricant in the direction of the drive.

The invention relates to a trench wall cutter according to the preamble of claim 1. Such a trench wall cutter comprises a cutting frame, a bearing plate or bracket located on the cutting frame, at least one cutting wheel mounted in rotary manner on the bearing plate, a drive fitted to the cutting frame spaced from the bearing bracket, a gear or transmission located in the bearing bracket, and a drive shaft transmitting a drive torque to the transmission in the bearing bracket.

A trench wall cutter having these features can e.g. be gathered from EP 0 848 112 B1. By moving the drive from the bearing bracket to a location on the cutting frame spaced from the cutting wheels a compact trench wall cutter is created. For transmitting the drive torque to the transmission or gear in the bearing bracket use is made of a relatively long drive shaft.

The lower bearing of the drive shaft is lubricated by the transmission oil in the gearbox. As a result of the increased distance between the transmission in the bearing bracket and the drive the upper bearing of the drive shaft cannot or can scarcely be directly lubricated by lubricants from the gearbox in the bearing bracket. There is a risk of increased bearing wear due to inadequate lubrication.

A dry running of the seals and bearings must be prevented, because as a result of no longer functioning seals suspension located in the cut trench for supporting the same can penetrate the transmission and the drive of the trench wall cutter. Apart from the additional costs resulting from such an incident and which is necessary for the draining of the transmission and the drive, in very unfavourable cases damage can be caused to the trench wall cutter.

However, a replacement of the bearings or seals for maintenance purposes also requires a dismantling of the trench wall cutter, which is unavailable for use during this time period. Problems also arise if such a maintenance interval occurs during cutting and consequently cutting has to be interrupted, the trench wall cutter has to be removed from the cut trench, maintained and then reintroduced into the cut trench.

In the case of trench wall cutters according to the preamble use is either made of permanently lubricated bearings or for the movable parts and seals in the upper end region of the drive shaft a separate grease lubrication is installed. However, this involves increased maintenance costs, because the bearings and seals have to be checked and replaced in short cycles. This also increases the operating costs and reduces the effective use period of the trench wall cutter.

The object of the invention is therefore to provide a trench wall cutter with the features according to the preamble, but where the maintenance costs are particularly low.

According to the invention this object is achieved by a trench wall cutter having the characterizing features of claim 1. Advantageous embodiments are given in the dependent claims.

According to the invention the drive shaft at least partly has an external thread constructed as a feed thread for feeding lubricants in the direction of the drive.

It is a fundamental idea of the invention to feed through the drive shaft extending from the gearbox to the drive lubricant from the gearbox to the elements to be lubricated of the fixing of the drive to the drive shaft. For this purpose the drive shaft is constructed with an external thread which is used as a feed thread for feeding lubricant during the rotation of the drive shaft. As a result of the transport of the lubricant from the transmission in the bearing bracket in the direction of the drive at the junction of the drive with the drive shaft there is no need for permanently lubricated bearings or a separate grease lubrication. As a result the necessary maintenance intervals can be significantly increased. The risk of bearings or seals running dry is essentially prevented. The effective operating period of a trench wall cutter and consequently the productivity thereof is increased.

It is fundamentally possible to use greases for lubricating the bearings and seals, but transmission or gear oil is particularly suitable for this purpose. When using greases or other lubricants the transport through the feed thread of the drive shaft is more difficult and is highly dependent on the viscosity of the lubricant. Consequently it is particularly advantageous to use for this purpose transmission oil which is located in the transmission in the bearing bracket. As a result there is no need to use a second and different lubricant. There is also no need for storage areas for any other lubricant.

In an advantageous embodiment at the upper end of the drive shaft is provided a distributing device for the further distribution of the lubricant. This distributing device sprays the lubricant fed through the drive shaft. Thus, lubrication is possible of all the seals and-bearings located on the drive and upper area of the drive shaft. The distributing device can be constituted by spray projections or edges on the driven shaft.

In an advantageous embodiment of the distributing device for the further distribution of the lubricant, said device is provided with a tooth system. This tooth system can be used both for drive torque transmission to the drive shaft and for lubricant distribution. This takes place in a particularly simple manner, because for drive torque transmission the drive shaft is put into movement and the lubricant is sprayed through the rotation and the tooth system in the connecting sleeve. Due to the fact that said tooth system is also used for torque transmission, no additional component has to be provided in the connecting sleeve for distributing the lubricant.

It would fundamentally be possible to transport in the drive direction through the drive shaft feed thread lubricant sprayed through the transmission in the bearing bracket. However, it is very difficult to reliably transport in the drive direction a sufficiently large lubricant quantity. In particularly simple manner a minimum necessary transport quantity can be ensured by providing a receptacle for lubricants and into which at least extends a lower end of the drive shaft external thread. This receptacle brings about a continuous transport of adequate lubricant quantities in the direction of the drive without any additional monitoring device. This further reduces the risk of the seals or bearings running dry.

In an advantageous embodiment in the vicinity of the driven side of the drive is provided at least one bearing, particularly a roll bearing, and the drive shaft is constructed for lubricating the at least one bearing. As a result of the bearing lubrication by lubricants transported and distributed from the bearing bracket through the drive shaft, a maintenance-intensive grease lubrication of the bearing can be obviated or simplified. In addition, there is no longer a need for self-lubricating bearings, which also involve increased costs and maintenance effort.

In another advantageous embodiment, in an area of the driven side of the drive is provided at least one seal, particularly a sliding seal, and the drive shaft is constructed for the lubrication of the at least one seal. Through the transport of lubricants from the gearbox in the bearing bracket through the drive shaft external thread and lubricant distribution by a distributing device, there is no longer a need for a maintenance-intensive grease lubrication for seals located in the vicinity of the driven side of the drive. A regular monitoring for checking the lubrication of the seal is consequently less frequently needed. The risk of support suspension penetrating from the cut trench is also reduced by the continuous lubrication of the seal.

A particularly preferred trench wall cutter is also characterized in that between the drive and the drive shaft is provided a connecting sleeve, on whose outside is located at least one bearing and/or at least one seal. As a result of this design there is firstly a particularly good sealing of the connecting sleeve and the drive with respect to the suspension in the cut trench and secondly the bearings help to ensure that the connecting sleeve is mounted in stable, but still low-friction manner around the drive and drive shaft. This leads to increased durability of the drive, connecting sleeve and drive shaft of a trench wall cutter.

The invention is described in greater detail hereinafter relative to a preferred embodiment and the attached diagrammatic drawings, wherein show:

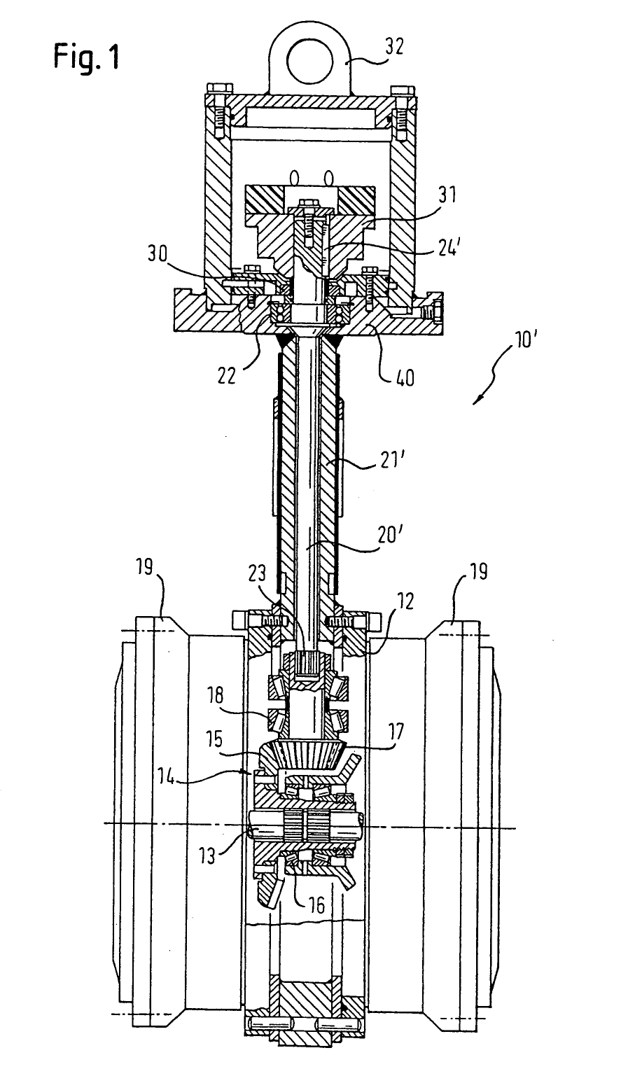

FIG. 1 A part cross-section through a side view of a trench wall cutter according to the preamble.

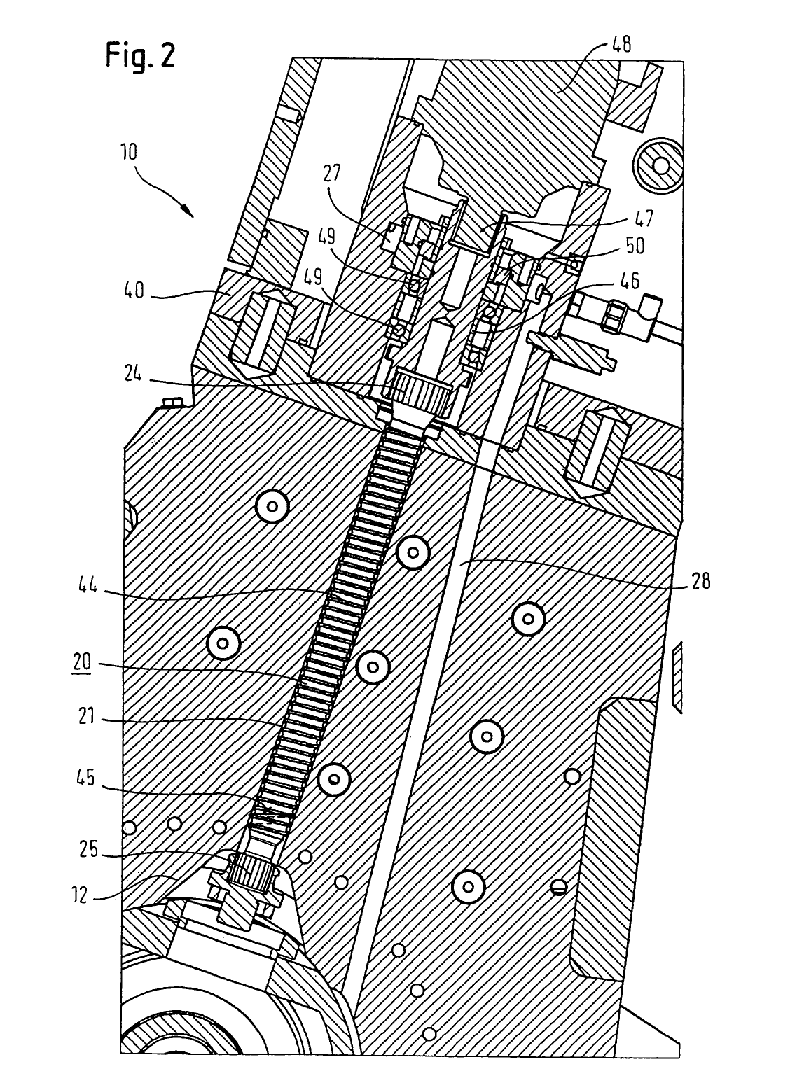

FIG. 2 A cross-section through a larger scale front view of a trench wall cutter according to the invention.

The basic construction of a trench wall cutter 10′ can be gathered from FIG. 1. A pair of cutting wheel hubs 19 driven by means of a cutting wheel shaft 13 is located on a bearing bracket 12. The cutting wheels can be detachably fixed to the cutting wheel hubs 19. A bevel gear drive 14 is located within the bearing bracket 12, which comprises several plates. The drive shaft 13 is connected to a crown wheel 15, which is held in rotary manner on the bearing bracket 12 by means of crown wheel bearings 16. The crown wheel 15 meshes with a driving pinion 17, whose rotation axis extends substantially perpendicular to the cutting wheel shaft 13. The driving pinion 17 is mounted in rotary manner in the bearing bracket 12 by means of two pinion bearings 18.

To keep the bearing bracket 12 as compact as possible, the not shown drive is positioned above bearing bracket 12 on cutting frame 40. The driving pinion 17 is connected by means of a first torque proof joint 23 to a drive shaft 20′ extending upwards to the drive parallel and centrally with respect to the driving pinion 17. At the upper end of the drive shaft 20′, which is surrounded in fluid-tight manner by a transmission or gear plate 21′, is located a second torque proof joint 24′, which is in this case a key and slot joint. The latter is used for connection to a coupling element 31 by means of which the torque is transmitted from the drive to the drive shaft 20′. The drive shaft 20′ is mounted in rotary manner by means of a drive shaft bearing 22 on cutting frame 40 and said bearing 22 is located in fluid-tight manner in a bearing housing 30. Finally, on the cutting frame 40 is provided a holder 32 by means of which the trench wall cutter 10′ can be transported.

The components described in conjunction with FIG. 1 and which are accompanied by a reference numeral not followed by an apostrophe, can be provided with no significant changes on the inventive trench wall cutter 10.

FIG. 2 shows an inventive trench wall cutter 10. On a drive shaft 20 a curved tooth coupling 25 is provided at the lower end in bearing bracket 12. At the other, upper end of the drive shaft 20 is fixed a distributing device. The drive shaft 20 is located in a gear plate 21 adjacent to the external thread 44 of drive shaft 20. The oil level in the transmission or gear of the trench wall cutter 10 extends to the lower end of the drive shaft 20. As a result of the external thread 44 of drive shaft 20 it is possible through a corresponding rotation to feed transmission oil from the transmission in the direction of the drive 28.

The oil delivered through the drive shaft 20 is radially sprayed by the distributing device 24 within the connecting sleeve 46 and to this end said device 24 has a spray edge. In the illustrated form the distributing device 24 is also constructed as a component with an outward curved tooth system. Through the radial spraying of the lubricant the ball bearings 49 in the connecting sleeve 46 are supplied with sufficient lubricant. The slip ring seal 50 is also prevented from drying out by the spraying of the lubricant. The connecting sleeve.46 connects the driven motor shaft 47 of drive 48 to the drive shaft 20. Both the drive 48 and the connecting sleeve 46 are protected within the cutting frame 40. Excess lubricant can be led from the upper area via a ring duct 27 and a return bore 28 downwards to the transmission where cooling takes place.

As a result of the trench wall cutter according to the invention its maintenance costs can be considerably reduced.

1. Trench wall cutter comprising
a cutting frame,
a bearing bracket located on the cutting frame,
at least one cutting wheel mounted in rotary manner on the bearing bracket,
a drive fitted to the cutting frame spaced from the bearing bracket,
a transmission located in bearing bracket and
a drive shaft transmitting a torque of the drive to the transmission in bearing bracket, wherein
the drive shaft at least partly has an external thread constructed as a feed thread for feeding
lubricant in the direction of the drive.

2. Trench wall cutter according to claim 1,
wherein
the delivered lubricant is a transmission oil from the transmission in bearing bracket.

3. Trench wall cutter according to claim 1,
wherein
a distributing device for the further distribution of the lubricant is provided at the upper end of the drive shaft.

4. Trench wall cutter according to claim 3,
wherein
the distributing device for the further distribution of the lubricant has a tooth system.

5. Trench wall cutter according to claim 1,
wherein
a receptacle for lubricant is provided and into it extends at least a lower end of the external thread of the drive shaft.

6. Trench wall cutter according to claim 1,
wherein
in an area of the driven side of the drive is provided at least one bearing, particularly a roll bearing and
that the drive shaft is constructed for the lubrication of the at least one bearing.

7. Trench wall cutter according to claim 1,
wherein
in an area of the driven side of the drive is provided at least one seal, particularly a slip ring seal and
that the drive shaft is constructed for lubricating the at least one seal.

8. Trench wall cutter according to claim 6,
wherein
between the drive and the drive shaft is provided a connecting sleeve, on whose outside is located the at least one bearing and/or the at least one seal.
